(19) United States
(12) Patent Application Publication
(10) Pub. No.: US 2006/0243718 A1
(43) Pub. Date: Nov. 2, 2006

(54) Torque boost for wire feeder

(75) Inventor: Edward A. Enyedy, Eastlake, OH (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Lincoln Global, Inc., a Delaware Corporation

(21) Appl. No.: 11/120,240

(22) Filed: May 2, 2005

(51) Int. Cl. B23K 9/10

(52) U.S. Cl. 219/137.71

(57) ABSTRACT

A wire feeder control system that augments the torque generated by the wire feed motor at lower wire feed speeds (WFS). This augmentation of the torque is accomplished by varying the current control level to the wire feed motor at least partially over the WFS range of the wire feeder.

This invention relates generally to wire feeders used in arc welding, and more particularly, to protecting a wire feed motor during the feeding of welding wire.

### BACKGROUND OF THE INVENTION

Many welding applications such as MIG (metal inert gas) or GMAW (gas metal arc welding) utilize a wire feeder to provide a consumable electrode to a workpiece to form a weld bead on the workpiece. Typically, the wire feeder feeds the consumable electrode at a generally constant speed; however, variable wire feed speeds can be selected. A typical wire feeder includes a motor that pulls the consumable electrode from a reel, spool or drum and feeds the consumable electrode wire at a wire feed speed to the welding arc. The wire feeder motor is controlled by a wire feed speed controller that may be a stand alone controller or may be part of a controller that controls other aspects of the welding process. The wire feed controller controls the speed of the wire feeder motor and commonly includes a potentiometer or digital controller which the operator uses to set wire feed speed. When a MIG welding system is used, the wire feeder commonly is integrated with the welding system. In such a welding system, the purpose of the wire feeder is to pull a consumable electrode from a spool, reel or drum and propel the consumable electrode through a welding gun to the welding arc. The propelling action of the wire feeder commonly occurs by the use of a series of rollers that grip the consumable electrode and propel the consumable electrode forward as the roller rotates. Typically, the series of rollers are driven by an electric motor. Typically, a DC permanent magnet motor is used since such motors are typically the cheapest; however, AC motors, DC brushless motors or stepper motors can also be used.

During operation of a welder, the operator typically pulls a trigger on the welding gun when a welding operation is to be performed. The trigger in the welding gun typically causes power to be directed to the wire feed motor to cause the consumable electrode to be propelled to the welding arc. When the trigger on the welding gun is released by the operator, power is typically terminated to the wire feed motor and the welding arc. Under normal operating conditions, the wire feeder provides the consumable electrode wire to the welding arc and the current draw of the wire feed motor is within an acceptable range of operation for the motor. In certain situations during the operation of the arc welder, the current draw of the wire feed motor will be outside normal operating ranges thereby causing the motor to overheat. This overheating situation can occur when large diameter consumable electrodes are used. Larger diameter consumable electrodes are more difficult to feed through a wire feeder since the stiff, large diameter electrode resists bending within the welding gun or conduit to the welding gun. As such, the wire feed motor has to draw more current to force the electrode through the welding gun and to the welding arc. The overheating of the motor can cause damage to the motor and/or cause other problems to other components of the welding system.

One common method to prevent motor damage from excessive current draw is to provide a fuse or fusible link electrically between the motor and power source. When excessive current is drawn, the fuse that opens the current to the motor is terminated. However, when a fuse or fusible link is used, the fuse or fusible link must to replaced or reset prior to restarting the wire feeder, thus causing inconvenience and down-time of the welding system. Another known device that is used to protect the wire feed motor is a thermistor. The thermistor can be used as a protective element and/or a control element, wherein the thermistor is used to inhibit current to the motor under extreme conditions, and/or controls the magnitude of power provided to the motor under normal conditions. One particular thermistor is disclosed in U.S. Pat. No. 6,204,479, which is incorporated herein by reference. A PTC thermistor is disposed electrically between the power supply and the wire feed motor. Under normal current conditions, the PTC thermistor allows current to be provided to the wire feed motor from the power supply; however, under excessive current conditions, the PTC thermistor inhibits current from being provided to the wire feed motor from the power supply. The wire feed motor disclosed in the '479 patent is a DC motor, thus the power supply to the motor provides current in a single direction. As such, the current is disclosed to flow from the power supply, through the PTC thermistor, and then to the motor. The PTC thermistor is disclosed to not be shunted by a resistor and/or a varistor, and/or is not in parallel with a relay.

Other methods to protect the wire feed motor from damage include the use of an external circuit that is used to terminate the welding process when the current to the motor exceeds a set limit. This external circuit can include a circuit breaker, PTC, NTC and/or a software program. When the set limit is exceeded, the welding process is disabled for a given time to allow the wire feed motor to cool. The advantage of these types of circuits are that such circuits incorporate simple components and/or a simple algorithm. However, none of the circuits facilitate in solving the problem of the wire feed motor overheating when feeding larger diameter electrodes. These circuits are only designed to prevent damage to the motor by temporarily terminating the operation of the motor.

In view of the current state of the art regarding wire feeder, there is a need for a motor controller that can operate a wire feed motor during the use of large diameter electrodes and reduce the incidence of the motor overheating during the feed of such electrode to a welding arc.

### SUMMARY OF THE INVENTION

The present invention is directed to an improved wire feeder for a welding system that overcomes the past problems of overheating the wire feeder motor, and more particularly to a control system for a wire feeder that reduces the incidence of overheating the wire feeder motor when feeding a large diameter consumable electrode through a welding gun and to the welding arc. The wire feeder of the present invention includes a wire feed motor and a wire feed power supply in electrical communication with the wire feed motor. A feeder electrical circuit is integrated with the power supply and the wire feed motor to adjust the amount of power that is directed to the wire feed motor. In one embodiment of the invention, the feeder electrical circuit selects and/or controls the amount of current and/or power supplied to the wire feed motor. The feeder electrical circuit, can use one or more hard wire circuits, microprocessors, databases, mathematical algorithms, etc. to control the wire feed motor. Power to the wire feed motor is based on the amount of voltage and current supplied to the wire feed motor. In prior art wire feeders, the current to the motor was held constant and the voltage was varied to adjust the speed of the motor. As such, the voltage was increased to increase the speed of the motor and the voltage was decreased to decrease the speed of the motor. The present invention is a departure from prior art wire feeders in that the current to the wire feed motor is not held constant when adjusting the speed of the motor. It has been found that by adjusting the current to the wire feed motor, the amount of torque generated by the motor can be increased at lower operation speeds without damage to the motor. Such higher torque values enable the wire feeder to feed larger diameter consumable electrodes, which are typically fed at lower speeds, to the welding gun and reduce the overheating problems commonly associated with the feeding of such consumable electrodes.

In another aspect of the present invention, the feeder electrical circuit includes a microprocessor that calculates and/or accesses feeder data relating to current, voltage and/or power values to the wire feed motor based upon a selected wire feed speed (WFS), power level and/or wire feed motor. The feeder data can be in a modifiable or unmodifiable form. If the feeder data is modifiable, the feeder data can be updated; however, this is not required. The feeder data can include information on current, voltage, Watts, WFS, wire type, and/or motor type. As can be appreciated, the data can include other information. In one non-limiting embodiment of the invention, the feeder data provides a current and voltage value for a selected WFS. As such, for each WFS selected by an operator, the microprocessor accesses and/or calcualtes the feeder data and obtains a voltage and current value that is to be directed to the wire feed motor to achieve the selected WFS for the consumable electrode. When a low WFS is selected by the operator, the feeder data that corresponds to such WFS includes a larger current value and lower voltage value than used in prior art wire feeder systems. This higher current value results in greater torque generated by the wire feeder for a selected WFS. When a higher WFS is selected by the operator, the feeder data that corresponds to such WFS includes a standard or lower current value and standard or higher voltage value as compared with prior art wire feeder systems. In another non-limiting embodiment of the invention, the feeder data provides current and voltage values to correspond to a selected power setting by an operator. In this situation, the operator selects a WFS and a power value. The selected power value can be a relative value (e.g., low setting, medium setting, high setting, etc.), an adjusted value (e.g., −50 W, −30 W, −10 W, +10 W, +30 W, +50 W, etc.) or be a more exact setting (e.g., 200 W, 300 W, 400 W, etc.). As can be appreciated, other or additional arrangements can be used. Based on the selected WFS and power value, the microprocessor accesses and/or calculates the feeder data to obtain the corresponding current and voltage values that are to be directed to the wire feed motor to achieve the desired WFS and power supply to the motor. In still another non-limiting embodiment of the invention, the feeder data corresponds to the type of wire feed motor. Different sizes of motors have different power ratings. In addition, different types of motors (e.g., DC permanent magnet motors, AC motors, DC brushless motors, stepper motors, etc.) have different operating characteristics. The accessed and/or calculated feeder data can provide current, voltage, power and/or WFS information that corresponds to a particular size and/or type of wire feed motor. In yet another non-limiting embodiment of the invention, the feeder data can be in a variety of forms. One form of the feeder data can be a database that includes values for one or more of the following variables, namely, current, voltage, WFS, power (e.g., Watts, etc.), feed motor type, feed motor size, consumable electrode type, consumable electrode size, etc. When such a database is used, a microprocessor is typically used to access this database and obtain values based on one or more preset and/or selected settings (e.g., WFS, power, feed motor type, feed motor size, consumable electrode type, consumable electrode size, etc.). Another or additional form of the feeder data, the feeder data is fully or partially generated by a mathematical algorithm. When one or more values are generated by a mathematical algorithm, a microprocessor is used to access run this mathematical algorithm and obtain values based on one or more preset and/or selected settings (e.g., WFS, power, feed motor type, feed motor size, consumable electrode type, consumable electrode size, etc.).

In still another aspect of the invention, the feeder electrical circuit includes a circuit breaker, PTC, NTC and/or a software program to terminate current and/or voltage to the wire feed motor from the power supply so as to inhibit or prevent damage to the wire feed motor in an overheating situation. In certain situations, a consumable electrode feed problem can occur (e.g., tangling and/or jamming of the electrode, etc.). When such a problem occurs, the consumable electrode cannot be advanced by the wire feed motor, thus the motor begins to overheat. In such situations, a circuit breaker, PTC, NTC and/or a software program is used to terminate current and/or voltage to the wire feed motor to inhibit or prevent damage to the motor from overheating and to enable an operator to correct the feed problem.

One object of the present invention is the provision of a wire feeder that can feed various sizes of consumable electrodes with reduced incidence of overheating the wire feed motor.

Another object of the present invention is the provision of a wire feeder that includes a feeder an electrical circuit that can control the current and power levels to the wire feed motor.

Still another object of the present invention is the provision of a wire feeder that includes a feeder electrical circuit that calculates and/or accesses current, voltage and/or power values that are to be used to operate the wire feed motor.

Yet another object of the present invention is the provision of a wire feeder that includes a wire feed motor that generates higher torque values as compared with prior art wire feed motors when feeding large diameter consumable electrodes to a welding gun.

These and other objects and advantages will become apparent from the following description taken together with the accompanying drawings.

### BRIEF DESCRIPTION OF THE DRAWINGS

Reference may now be made to the drawings, which illustrate an embodiment that the invention may take in physical form and in certain parts and arrangements of parts wherein;

FIG. 1 illustrates a block diagram of a prior art welding system that includes a wire feeder control to control the speed of a consumable electrode through a welding gun;

FIG. 2 illustrates a block diagram of a prior art electrical circuit for a wire feed motor;

FIG. 3 illustrates a block diagram of another prior art electrical circuit for a wire feed motor;

FIG. 4 illustrates a block diagram of another prior art electrical circuit for a wire feed motor;

FIG. 5 illustrates a block diagram of another prior art electrical circuit for a wire feed motor;

FIG. 6 illustrates a block diagram of a general electrical circuit for a wire feed motor in accordance with the present invention;

FIG. 7 illustrates a block diagram of one specific electrical circuit for a wire feed motor in accordance with the present invention;

FIG. 7A illustrates a graft of the current value to WFS relationship of the current reference values illustrated in FIG. 7;

FIG. 8 illustrates a block diagram of another specific electrical circuit for a wire feed motor in accordance with the present invention;

FIG. 9 illustrates a block diagram of another specific electrical circuit for a wire feed motor in accordance with the present invention; and,

FIG. 10 illustrates a graft of the enhanced motor torque in relation to the WFS of the motor and the power to the motor in accordance with the present invention.

### DETAILED DESCRIPTION OF THE INVENTION

Referring now to the drawings wherein the showings are for the purpose of illustrating the preferred embodiment only and not for the purpose of limiting the same, FIGS. 1-5 illustrate various prior art arrangements of wire feeders used in conjunction with a welding system such as, but not limited to, a MIG or GMAW welding system. As illustrated in FIG. 1, there is schematically illustrated a welding system 20 that includes a power supply 30 which provides current to the tip 40 of a welding gun so as to generate an electric arc A between the tip of the welding gun and a workpiece W. A shielding gas G can be provided through the welding gun to provide shielding to the weld metal from undesired elements and/or compounds in the surrounding environment. The welding system also includes a consumable electrode source 50 which is illustrated to be in the form of a reel of wire; however, a drum of wire or other wire source can be used. The consumable electrode 60 is drawn from the consumable electrode source 50 by drive rollers 70 which form part of the weld wire feeder. A wire feed motor 80 causes the drive roller to rotate at a certain speed so that the consumable electrode 60 is fed through the welding gun at a desired WFS. Motor 80 is a DC motor and the power supply to the motor is a DC power source; however, it can be appreciated that other types of motors and power supplies can be used. The speed of the wire feed motor 80 is controlled by a standard control circuit 100. A preset or manually selected command 110 sets the WFS. This WFS command is sent to a microprocessor 120. The microprocessor directs a certain voltage level V to the wire feed motor based on the received WFS command. The current to the wire feed motor is maintained at a relatively constant level, thus the control of the speed of the wire feed motor is by the voltage level directed to the wire feed motor. As can be appreciated, a potentiometer and/or other type of circuit can be used to direct a voltage V to the wire feed motor, thus eliminating the use of microprocessor 120. Control circuit 100 also includes an overheating protection system to protect the wire feed motor 80 from becoming overheated during the operation of the welding system. This overheating protection system includes a current detector 130 that detects the amount of current being drawn by the wire feed motor. When the current level detected by the current detector 130 is above a preset upper limit, a circuit breaker 140 is opened thereby terminating the operation of the wire feed motor 80. The opening of the circuit breaker can be an automatic operation of the circuit breaker and/or can be at least partially controlled by microprocessor 120 and/or one or more other control circuits. The time period that the circuit breaker remains open may be a preset time, a manually set time, etc. The circuit breaker can be designed to be manually and/or automatically reset. The opening of the circuit breaker can also cause power source 30 to terminate; however, this is not required. Power supply 30, control circuit 100 and the components of the wire feeder are shown as discrete blocks; however, in practice, these components can be part of a single housed unit or can be separate and distinct components of the welding system.

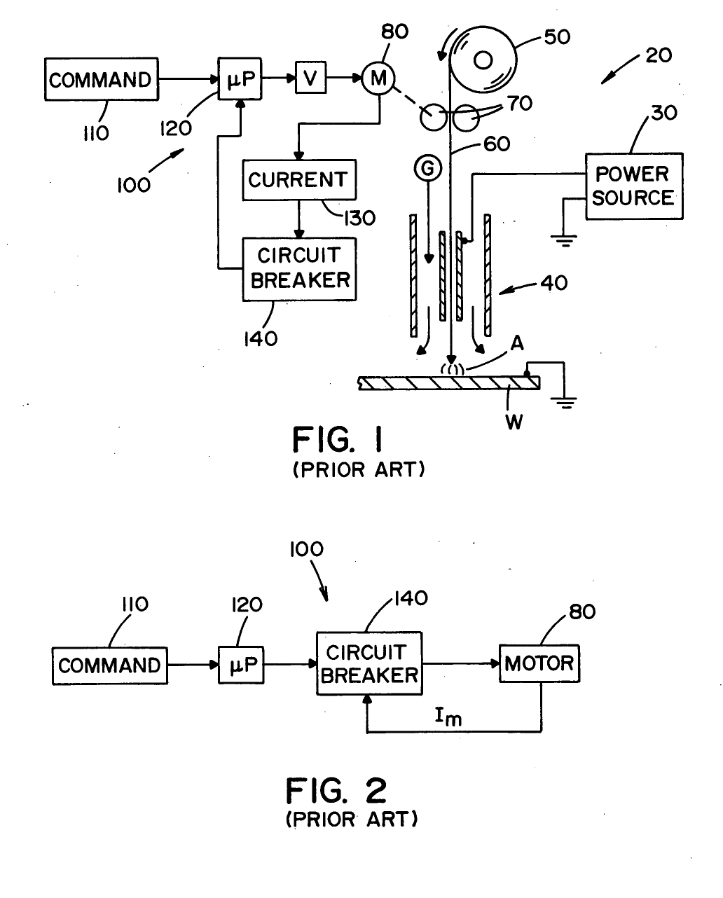

Referring now to FIG. 2, another prior art arrangement control circuit 100 is illustrated for controlling of the wire feed motor 80. In this particular control arrangement, a WFS command 110 is preset or manually selected by an operator. This WFS command is directed to microprocessor 120. The microprocessor controls a certain power (Watts) to the wire feed motor based on the received WFS command. The current to the wire feed motor is maintained at a relatively constant level, thus the control of the speed of the wire feed motor is by the voltage level directed to the wire feed motor. The overheating of the wire feed motor 80 is protected by the use of circuit beaker 140. Circuit breaker 140 is positioned between the power output controlled by the microprocessor and the wire feed motor 80. The circuit breaker receives current output signal Iₘ from the wire feed motor. When the current level is above a preset upper limit, circuit breaker 140 opens, thereby terminating the operation of the wire feed motor 80. The time period that the circuit breaker remains open may be a preset time, a manually set time, etc. The circuit breaker can be designed to be manually and/or automatically reset. The opening of the circuit breaker can also cause power source 30 to terminate; however, this is not required.

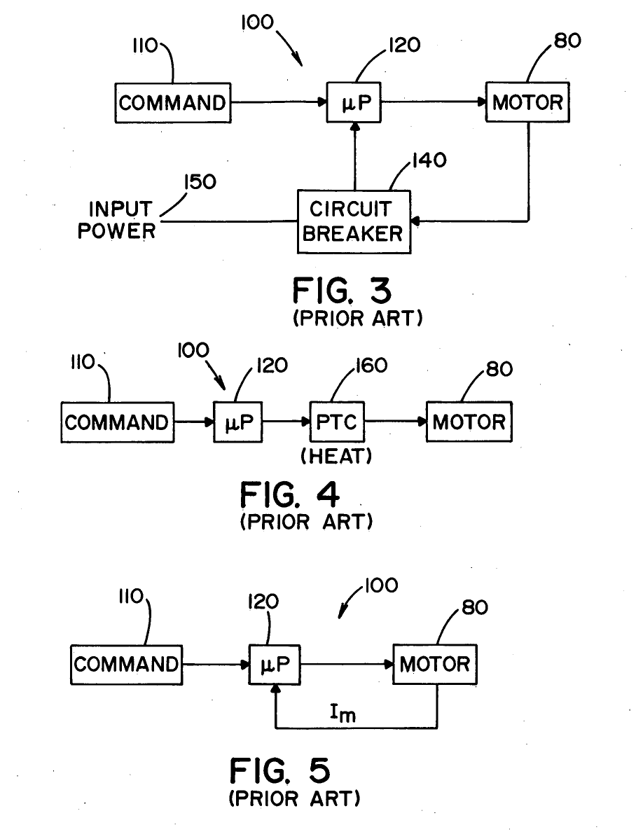

Referring now to FIG. 3, another prior art arrangement control circuit 100 is illustrated for controlling of the wire feed motor 80. In this particular control arrangement, a WFS command 110 is preset or manually selected by an operator. This WFS command is directed to microprocessor 120. The microprocessor controls a certain power (Watts) to the wire feed motor based on the received WFS command. The current to the wire feed motor is maintained at a relatively constant level, thus the control of the speed of the wire feed motor is by the voltage level directed to the wire feed motor. The overheating of the wire feed motor 80 is protected by the use of circuit beaker 140. Circuit breaker 140 is positioned between wire feed motor 80 and microprocessor 120. The circuit breaker receives current and voltage output signal and/or power output signal from the wire feed motor. A preset and/or manually selected power output setting 150 directs power into the circuit breaker, which in turn is directed to microprocessor 120. As can be appreciated, the power output setting 150 can be alternatively a maximum power output setting level that is compared with the power output received by the circuit breaker. When the power level is above a preset upper limit, circuit breaker 140 opens thereby terminating the operation of the wire feed motor 80. The time period that the circuit breaker remains open may be a preset time, a manually set time, etc. The circuit breaker can be designed to be manually and/or automatically reset. The opening of the circuit breaker can also cause power source 30 to terminate; however, this is not required.

Referring now to FIG. 4, another prior art arrangement control circuit 100 is illustrated for controlling of the wire feed motor 80. This control circuit is similar to the control circuit disclosed in U.S. Pat. No. 6,204,479, which is incorporated herein by reference. In this particular control arrangement, a WFS command 110 is preset or manually selected by an operator. This WFS command is directed to microprocessor 120. The microprocessor controls a certain power (Watts) to the wire feed motor based on the received WFS command. The current to the wire feed motor is maintained at a relatively constant level, thus the control of the speed of the wire feed motor is by the voltage level directed to the wire feed motor. The overheating of the wire feed motor 80 is protected by the use of PTC (positive temperature coefficient) thermistor 160. PCT thermistor 160 is positioned between the power output controlled by the microprocessor and the wire feed motor 80. The PTC thermistor is used to avoid damaging motor 80 when excessive current (e.g., 10%, 20%, or more excess current over the expected, typical, or rated current) is being drawn by the motor. PTC thermistor 160 provides over-current protection to the motor circuit. Under normal current conditions the PTC thermistor allows current to be provided to the wire feed motor from the power supply, but under excessive current conditions the PTC thermistor inhibits current from being provided to the wire feed motor from the power supply. When motor 80 draws excessive current, the excessive current causes the PTC thermistor to switch to a high impedance state, effectively opening the motor circuit. The PTC thermistor will remain in its high-impedance state until power is removed from the circuit and the PTC is allowed to cool. The time period that the PTC thermistor remains open may be a preset time, a manually set time, etc. The PTC thermistor can be designed to be manually and/or automatically reset. The opening of the PTC thermistor can also cause power source 30 to terminate; however, this is not required.

Referring now to FIG. 5, another prior art arrangement control circuit 100 is illustrated for controlling of the wire feed motor 80. In this particular control arrangement, a WFS command 110 is preset or manually selected by an operator. This WFS command is directed to microprocessor 120. The microprocessor controls a certain power (Watts) to the wire feed motor based on the received WFS command. The current to the wire feed motor is maintained at a relatively constant level, thus the control of the speed of the wire feed motor is by the voltage level directed to the wire feed motor. The overheating of the wire feed motor 80 is protected by the microprocessor. The microprocessor receives current output signal Iₘ from the wire feed motor. When the current level is above a preset upper limit, the microprocessor terminates and/or causes termination of voltage and/or current to the wire feed motor 80. The time period that the microprocessor terminates the operation of the motor may be a preset time, a manually set time, etc. The microprocessor can be designed to be manually and/or automatically reset. The microprocessor can also cause power source 30 to terminate; however, this is not required.

In all of the control circuits described above, the purpose of the control circuit is to prevent damage to the wire feed motor due to overheating. One or more of these control circuits can be used in the welding system of the present invention for such purpose. Although the control circuits illustrated in FIGS. 1-5 can be used to successfully inhibit or prevent damage to the wire feed motor 80 from over heating, none of these control circuits can provide added torque to the wire feed motor when lower WFS are selected and/or larger diameter consumable electrodes are used.

The novel method of operating the wire feed motor to obtain higher torque at lower WFS than were previously possible is by manipulation of the current level being directed to the wire feed motor. In prior art wire feeder, the current to the wire feed motor was maintained relatively constant and the WFS was adjusted by adjusting the voltage to the wire feed motor. When the current to the wire feed motor deviated a certain amount from this constant level, the operation of the wire feed motor was terminated as represented in the control circuits set forth in FIGS. 1-5. The present invention is a departure from the use of a generally constant current to the wire feed motor over all selected WFS.

The wire feed motors are designed for a given set point that is used to represent the maximum operating conditions of the wire feed motor. For instance, a wire feed motor may run at 140 rpm and produce about 11 Nm or torque using a input to the wire feed motor of about 28V and 10 Amps. The wire feed motor thus outputs about 161 Watts with 280 Watt input, thus has about a 58% efficiency. In the past, the current limit for such a wire feed motor was set at about 10 Amps and the motor speed was adjusted by adjusting the voltage to the motor from 0-28 V. When this same motor had a speed of about 50 rpms, the voltage was set to about 10V and the current remained at about 10 Amps. The input power to the wire feed motor is about 100 Watts and the output power is about 58 Watts. Since the current level of the wire feed motor remains at about 10 Amps, the maximum torque of the wire feed motor is 11 Nm.

The present invention is based on the discovery that at lower wire feed motor speeds, it is possible to increase the current limit to the wire feed motor without causing damage to the wire feed motor. Even though the wire feed motor efficiency at such higher current levels may be less than the maximum efficiency of the wire feed motor, the total power dissipated in the wire feed motor is less than the power dissipated by the wire feed motor under maximum operating conditions of the wire feed motor. For example, in the above wire feed motor, the wire feed motor under maximum operating conditions of 140 rps was able to dissipate about 119 Watts (280 Watts-161 Watts). At the lower speed of 50 rpms, the wire feed motor only dissipated about 42 Watts (100 Watts-58 Watts). As such, it has been found that the current to the wire feed motor can be increased at lower speeds to increase the torque of the motor without damaging the wire feed motor. For instance, the current to the wire feed motor at about 50 rpms could be increased to nearly 28 Amps. DC permanent magnet motors which are commonly used as wire feed motors have a generally linear relationship between current and torque. As such, if 28 Amps and 10V were directed to the wire feed motor to obtain the maximum rating of the wire feed motor of 280 Watts, the torque of such wire feed motor using such amp and voltage values could be as high as about 30.8 Nm. As can be appreciated, the upper current limit to the wire feed motor is not only limited to the maximum rating of the wire feed motor, but also to the current density of the brushes of the motor and the changes in motor efficiency as the motor heats up. As can be appreciated, other types of wire feed motors can be used (e.g., DC permanent magnet motors, AC motors, DC brushless motors, stepper motors, etc.).

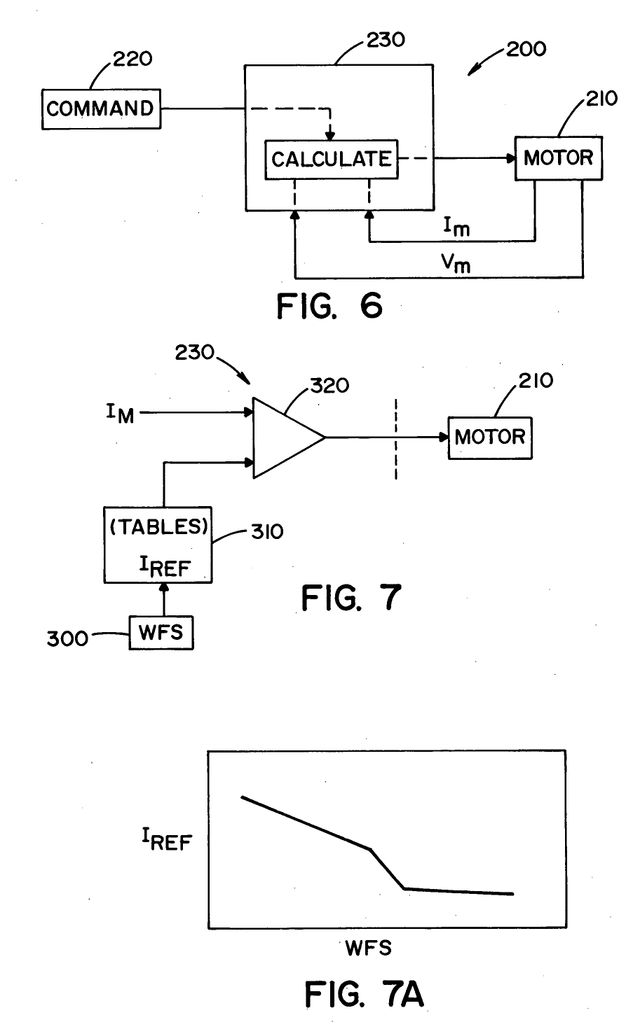

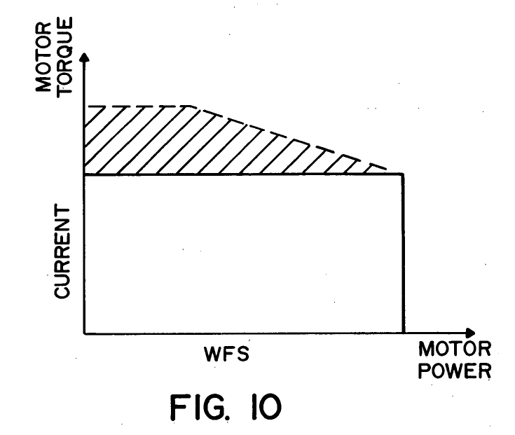

Referring now to FIG. 6, a control circuit 200 for controlling the weld feed motor 210 of a wire feeder in accordance with the present invention is illustrated. A WFS command 220 is preset or selected by an operator. Based on the selected WFS, a calculating circuit 230 selects or calculates a current control level and a voltage control level so as to control the current Iₘ and a voltage Vₘ for the wire feed motor so as to obtain a desired WFS of the consumable electrode and to cause the motor 210 to have higher torque values when the WFS is at lower values. Typically the calculating circuit is or includes one or more microprocessors; however, this is not required. A variety of arrangements can be used to select the current Iₘ and a voltage Vₘ for the wire feed motor. In one non-limiting arrangement, the command signal is a voltage signal such as from a potentiometer or digital device. When a potentiometer is used to generate the voltage, the potentiometer is typically a non-linear potentiometer; however, this is not required. When the microprocessor receives the voltage signal that is representative of the WFS, the microprocessor calculates or selects from a database a current control value that is used to control the current to the wire feed motor 210. In this particular arrangement, the current control value decreases as the selected WFS increases. The decrease in the current control value from the lowest to highest WFS that is generated by the wire feed motor can be a continuous decrease or non-continuous decrease. When the current decreases, the decrease can be a linear or nonlinear decrease. One such nonlinear current decrease is illustrated in FIG. 7. Another nonlinear current decrease is illustrated in FIG. 10. As can be appreciated, numerous current profiles can be used for the wire feed motor. In another non-limiting arrangement, the command signal is a current signal. The increase or decrease in the current control signal can be linear or non-linear. When the microprocessor receives the current control signal that is representative of the WFS, the microprocessor calculates or selects from a database a voltage control value that is to be sent to the wire feed motor 210. In this particular arrangement, the voltage control value increases as the selected WFS increases. The increase in the voltage control value from the lowest to highest WFS that is generated by the wire feed motor can be a continuous decrease or non-continuous decrease. When the voltage control value increases, the increase can be a linear or nonlinear increase. In still another non-limiting arrangement, the command signal is a WFS signal. When the microprocessor receives the WFS signal, the microprocessor calculates or selects from a database a voltage and current control value that is used to control the current and voltage to the wire feed motor 210. In this particular arrangement, the voltage control value increases and the current value decreases as the selected WFS increases. The increase in voltage control value and the decrease in the current control value as the WFS is increased can be a continuous decrease or non-continuous decrease. When the voltage control value increases, the increase can be a linear or nonlinear increase. When the current control value decreases, the decrease can be linear or non-linear. As can be appreciated many other control arrangements for the current and/or voltage can be used which are in accordance with the present invention.

Referring now to FIGS. 7 and 7A, one non-limiting embodiment of the calculating circuit 230 is illustrated. As shown in FIG. 7, a WFS 300 is manually or automatically selected. The WFS signal can be digital or non-digital. The selected WFS typically is representative of the voltage control value that is used to control the voltage to the wire feed motor; however, this is not required. The selected WFS corresponds to a certain current control value or current reference value I_{REF} for the wire feed motor 210. The current reference value I_{REF} is shown to be included in a database of values 310; however, it can be appreciated that the current reference value could be a calculated value. The current reference value I_{REF} is typically selected for a particular type and size of wire feed motor. As illustrated in FIG. 7A, the current reference value I_{REF} is not a constant value over the WFS range. The I_{REF} is shown to have a nonlinear relationship to the selected WFS. As can be appreciated, the current reference value I_{REF} can decrease in one or more linear relationships over the partial or full WFS range. The current reference value is shown to decrease as the WFS increases. At a lower WFS, the higher current to the wire feed motor results in a larger torque value generated by the wire feed motor. This higher torque beneficial consumable electrode is being used in the welding system. As can be appreciated, database 310 or another database can include the voltage control value or voltage reference value for controlling the voltage to the motor based on the selected WFS; however, this is not required. The changing of the current to the wire feed motor as the WFS is changed is novel to the art of welding. Referring again to FIG. 7, the current reference value I_{REF} is compared in a comparing device 320 to the actual current I_{M} that is being sent to the wire feed motor. The comparing device causes the I_{M} to adjust to the current reference value I_{REF} during the operation of the wire feed motor.

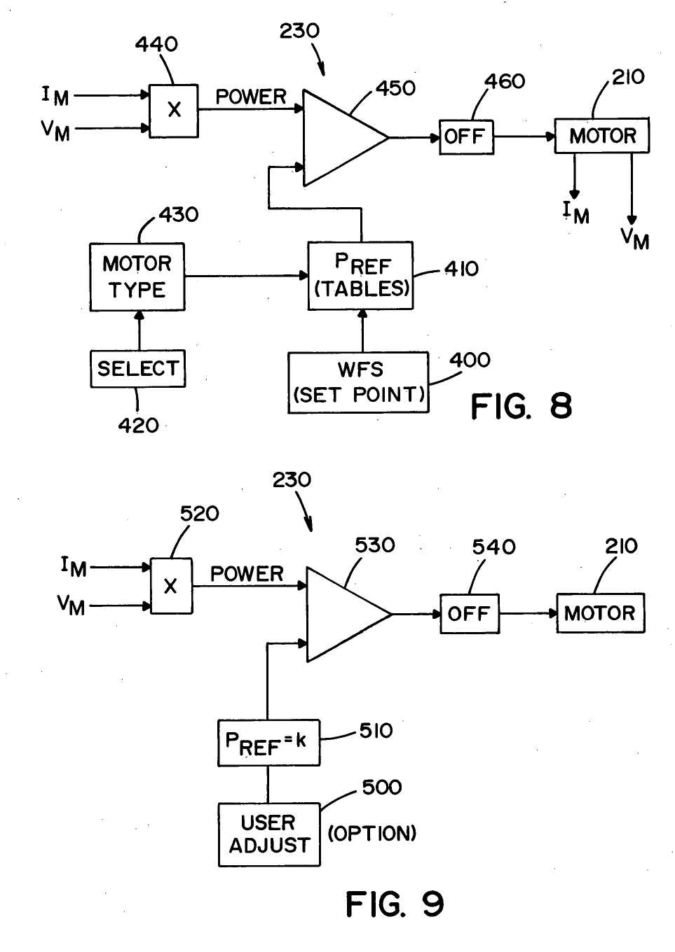

Referring now to FIG. 8, another non-limiting embodiment of the calculating circuit 230 for controlling wire feed motor 210 is illustrated. As shown in FIG. 8, a WFS 400 is manually or automatically selected. The WFS signal can be digital or non-digital. The selected WFS corresponds to a certain power control value or power reference value P_{REF} to control the power to the wire feed motor 210. The power reference value P_{REF} is shown to be included in one or more databases of values 410; however, it can be appreciated that the power reference value could be a calculated value. The power reference value P_{REF} is typically selected for a particular type and size of wire feed motor. In one optional design of the calculating circuit, the type and/or size of wire feed motor can be selected by selector 420. This selection can be an automatic or manual selection of the motor type and/or size. The selected motor type 430 is transmitted to database 410 so that the appropriate power reference value for a particular type of wire feed motor is selected for the selected WFS. This optional design can be used when the wire feed is a separate component of the welding system. When the wire feeder is a separate component, various types of wire feeders may be used in the welding system. These various types of wire feeder can have different sizes and/or types of wire feed motors. As such, this optional design accounts for such varying types of wire feed motors so as to select an appropriate power reference value for a particular type of wire feed motor for the selected WFS. When the wire feeder is an integrated component of the welding system, this optional design can be eliminated. The power reference values in database 410 are typically based on the motor efficiency characteristics. The power reference table typically provides a current reference value and a voltage reference value for use in controlling I_{M} and V_{M} during the operation of the wire feed motor; however, this is not required. As shown in FIG. 8, the I_{M} and V_{M} of the wire feed motor is directed to a summing component 440. The summing component generates a power value. Power is obtained by multiplying I_{M} and V_{M}. This power value is sent to a comparing component 450. The actual power being used to operate the wire feed motor is compared to the power reference value P_{REF}. The comparing component uses the power reference value P_{REF} to control the actual amount of power being sent to the wire feed motor. The I_{M} that is used to operate the wire feed motor is not constant over the WFS range. Typically the I_{M} and the V_{M} are not constant over the WFS range. Typically the I_{M} will decrease and the V_{M} will increase as the WFS increases. The increase in V_{M} and/or the decrease in I_{M} can be over the partial or full WFS range of the wire feed motor. As can also appreciated, the P_{REF} can be a constant or non-constant value over the WFS range. The P_{REF} for a particular type and size of wire feed motor for a particular WFS will depend on the efficiency characteristics of the wire feed motor. A power interruption component 460 can be used to terminate power to the wire feed motor. The power interruption component can be part of or a separate component from the calculating circuit 230. The power interruption component is designed to protect the wire feed motor from becoming overheated. The power interruption circuit can be the same as or similar to the safety circuits illustrated in FIGS. 1-5, or can be some other arrangement.

Referring now to FIG. 9, another non-limiting embodiment of the calculating circuit 230 for controlling wire feed motor 210 is illustrated. As shown in FIG. 9, a power setting 500 is manually selected. This manually adjusted power setting is optional. When no manual power setting is used, a preset or automatically set power setting is used by the calculating circuit. The manual set, preset or automatically set power setting creates a power reference setting P_{REF} 510. This P_{REF} is a constant value k that is used by the calculating circuit to control the power to the wire feed motor. The power reference table typically provides a current reference value and a voltage reference value for use in controlling I_{M} and V_{M} during the operation of the wire feed motor; however, this is not required. As shown in FIG. 9, the I_{M} and V_{M} of the wire feed motor is directed to a summing component 520. The summing component generates a power value. Power is obtained by multiplying I_{M} and V_{M}. This power value is sent to a comparing component 530. The actual power being used to operate the wire feed motor is compared to the power reference value P_{REF}. The comparing component uses the power reference value P_{REF} to control the actual amount of power being sent to the wire feed motor. The I_{M} that is used to operate the wire feed motor is not constant over the WFS range. Typically the I_{M} and the V_{M} are not constant over the WFS range. Typically the I_{M} will decrease and the V_{M} will increase as the WFS increases. The increase in V_{M} and/or the decrease in I_{M} can be over the partial or full WFS range of the wire feed motor. As can also be appreciated, the P_{REF} can be a constant or non-constant value over the WFS range. The P_{REF} for a particular type and size of wire feed motor for a particular WFS will depend on the efficiency characteristics of the wire feed motor. A power interruption component 540 can be used to terminate power to the wire feed motor. The power interruption component can be part of or a separate component from the calculating circuit 230. The power interruption component is designed to protect the wire feed motor from becoming overheated. The power interruption circuit can be the same as or similar to the safety circuits illustrated in FIGS. 1-5, or can be some other arrangement.

In the non-limiting embodiments of the invention illustrated in FIGS. 6-9, the current to the wire feed motor is increased at lower WFS and decreased at higher WFS so that the torque generated by the wire feed motor is greater at lower WFS. This relationship of greater motor torque at lower WFS in combination with the use of higher currents to the motor at lower WFS is illustrated in FIG. 10. FIG. 10 illustrates just one of many motor torque to WFS profiles that can be used in the present invention. Different types and sizes of motors may utilize different motor torque to WFS profiles. As illustrated in FIG. 10, the maximum allowable power to the wire feed motor can be varied over the WFS range of the wire feed motor. This increase in power in represented by the hatched area. In prior wire feed motor control arrangements, the maximum power to the wire feed motor remained generally constant as illustrated by the non-hatched region. As the WFS increases, the maximum allowable power to the wire feed motor deceases due to the limits on motor efficiency. The current limit and motor torque limit of the wire feed motor at lower WFS is limited by the brush current limit of the wire feed motor and/or other structural limits of the components of the-wire feed motor. As stated above with respect to FIG. 7A, different types and sizes of motors may utilize different current to WFS profiles. All these different possible profiles fall within the scope of the present invention. In summary, the present invention is directed to a wire feeder control system that can augment the torque generated by the wire feed motor at lower WFS. This augmentation of the torque is accomplished by varying the current control level to the wire feed motor at least partially over the WFS range of the wire feeder.

It should be apparent that there has been provided in accordance with the present invention a method and apparatus for generating high torque values for wire feed motors under certain conditions and also protecting the wire feed motor from overheating when feeding the consumable electrode that fully satisfies the objectives and advantages set forth above. It will thus be seen that the objects set forth above, among those made apparent from the preceding description, are efficiently attained, and since certain changes may be made in the constructions set forth without departing from the spirit and scope of the invention, it is intended that all matter contained in the above description and shown in the accompanying drawings shall be interpreted as illustrative and not in a limiting sense. The invention has been described with reference to preferred and alternate embodiments. Modifications and alterations will become apparent to those skilled in the art upon reading and understanding the detailed discussion of the invention provided herein. This invention is intended to include all such modifications and alterations insofar as they come within the scope of the present invention. It is also to be understood that the following claims are intended to cover all of the generic and specific features of the invention herein described and all statements of the scope of the invention, which, as a matter of language, might be said to fall therebetween.

I claim:

1. A wire feeder for arc welding comprising a wire feed motor, a power supply in electrical communication with the wire feed motor and a control circuit that controls current to the wire feed motor, said control circuit varying the current control level to the wire feed motor over at least a portion of a wire feed speed range of the wire feeder.

2. The wire feeder as defined in claim 1, wherein said control circuit controls voltage to the wire feed motor, said control circuit varying the voltage control level to the wire feed motor over at least a portion of said wire feed speed range of the wire feeder.

3. The wire feeder as defined in claim 1, wherein said control circuit controls the power to the wire feed motor, said control circuit varying the maximum allowable power control level to the wire feed motor over at least a portion of said wire feed speed range of the wire feeder.

4. The wire feeder as defined in claim 2, wherein said control circuit controls the power to the wire feed motor, said control circuit varying the maximum allowable power control level to the wire feed motor over at least a portion of said wire feed speed range of the wire feeder.

5. The wire feeder as defined in claim 1, wherein said current control level is a calculated value based on a particular wire feed speed.

6. The wire feeder as defined in claim 4, wherein said current control level is a calculated value based on a particular wire feed speed.

7. The wire feeder as defined in claim 5, wherein said control circuit calculates at least two values based on a particular wire feed speed, said at least two values selected from the group consisting of current control level, voltage control level, power control level, and combinations thereof.

8. The wire feeder as defined in claim 6, wherein said control circuit calculates at least two values based on a particular wire feed speed, said at least two values selected from the group consisting of current control level, voltage control level, power control level, and combinations thereof.

9. The wire feeder as defined in claim 1, wherein said current control level is a stored value in a database which corresponds to a particular wire feed speed.

10. The wire feeder as defined in claim 4, wherein said current control level is a stored value in a database which corresponds to a particular wire feed speed.

11. The wire feeder as defined in claim 9, wherein said database includes at least two values that correspond to a particular wire feed speed, said at least two values selected from the group consisting of current level, voltage level, power level, wire feed motor type, wire feed motor size, wire feed motor efficiency, type of wire feeder, type of consumable electrode, size of consumable electrode, and combinations thereof.

12. The wire feeder as defined in claim 10, wherein said database includes at least two values that correspond to a particular wire feed speed, said at least two values selected from the group consisting of current level, voltage level, power level, wire feed motor type, wire feed motor size, wire feed motor efficiency, type of wire feeder, type of consumable electrode, size of consumable electrode, and combinations thereof.

13. The wire feeder as defined in claim 1, wherein said control circuit is an overheat protection circuit to terminate power to said wire feed motor under excessive current conditions, under excessive overheating conditions, and combinations thereof.

14. A system for arc welding comprising a welding power supply to provide power to an electric arc, a wire feed motor to feed a consumable electrode to the electric arc, a wire feeder control circuit that controls current to the wire feed motor, said control circuit varying the current control level to the wire feed motor over at least a portion of a wire feed speed range of the wire feeder.

15. The system as defined in claim 14, wherein said control circuit controls voltage to the wire feed motor, said control circuit varying the voltage control level to the wire feed motor over at least a portion of said wire feed speed range of the wire feeder.

16. The system as defined in claim 14, wherein said control circuit controls the power to the wire feed motor, said control circuit varying the maximum allowable power control level to the wire feed motor over at least a portion of said wire feed speed range of the wire feeder.

17. The system as defined in claim 15, wherein said control circuit controls the power to the wire feed motor, said control circuit varying the maximum allowable power control level to the wire feed motor over at least a portion of said wire feed speed range of the wire feeder.

18. The system as defined in claim 14, wherein said current control level is a calculated value based on a particular wire feed speed.

19. The system as defined in claim 17, wherein said current control level is a calculated value based on a particular wire feed speed.

20. The system as defined in claim 18, wherein said control circuit calculates at least two values based on a particular wire feed speed, said at least two values selected from the group consisting of current control level, voltage control level, power control level, and combinations thereof.

21. The system as defined in claim 19, wherein said control circuit calculates at least two values based on a particular wire feed speed, said at least two values selected from the group consisting of current control level, voltage control level, power control level, and combinations thereof.

22. The system as defined in claim 14, wherein said current control level is a stored value in a database which corresponds to a particular wire feed speed.

23. The system as defined in claim 17, wherein said current control level is a stored value in a database which corresponds to a particular wire feed speed.

24. The system as defined in claim 22, wherein said database includes at least two values that correspond to a particular wire feed speed, said at least two values selected from the group consisting of current level, voltage level, power level, wire feed motor type, wire feed motor size, wire feed motor efficiency, type of wire feeder, type of consumable electrode, size of consumable electrode, and combinations thereof.

25. The system as defined in claim 23, wherein said database includes at least two values that correspond to a particular wire feed speed, said at least two values selected from the group consisting of current level, voltage level, power level, wire feed motor type, wire feed motor size, wire feed motor efficiency, type of wire feeder, type of consumable electrode, size of consumable electrode, and combinations thereof.

26. The system as defined in claim 14, wherein said control circuit is an overheat protection circuit to terminate power to said wire feed motor under excessive current conditions, under excessive overheating conditions, and combinations thereof.

27. The system as defined in claim 14, wherein sais wire feed motor is a DC motor.

28. The system as defined in claim 14, wherein said welding power supply, said wire feed motor and said wire feeder control circuit are integrated into a single unit.

29. A method of electric arc welding comprising:
a. providing a welding power supply to generate power to an electric arc;
b. providing a wire feed motor to feed a consumable electrode to the electric arc;
c. selecting at least one welding operation parameter;
d. providing a wire feeder control circuit to control the operation of said wire feed motor, said control circuit controlling a current level to said wire feed motor that is at least partially based on a wire feed speed, said controlled current level not constant over a full wire feed speed range of said wire feeder; and,
e. feeding said consumable electrode to said electric arc to transfer molten metal to a workpiece.

30. The method as defined in claim 29, wherein said step of selecting includes manually selecting, automatically selecting, and combinations thereof.

31. The method as defined in claim 29, wherein said step of selecting a plurality of welding operation parameters selected from the group consisting of wire feed speed, current level to said wire feed motor, voltage level to said wire feed motor, power level to said wire feed motor, wire feed motor type, wire feed motor size, wire feed motor efficiency, type of wire feeder, type of consumable electrode, size of consumable electrode, and combinations thereof.

32. The method as defined in claim 29, wherein said wire feeder control circuit calculating at least one control value based on at least one of said selected welding parameters, said control value including a value selected from the group consisting of current control level, voltage control level, power control level, and combinations thereof.

33. The method as defined in claim 29, wherein said wire feeder control circuit selecting at least one control value from at least one database, said at least one control value corresponding to at least one of said selected welding parameters, said control value including a value selected from the group consisting of current control level, voltage control level, power control level, and combinations thereof.
